(19) United States
(12) Patent Application Publication
(10) Pub. No.: US 2013/0066698 A1
(43) Pub. Date: Mar. 14, 2013

(54) AUTOMATIC REBATE GENERATION

(71) Applicants: Robert I. LEVY, Los Gatos, CA (US); Paul R. PATTERSON, Monte Sereno, CA (US)

(72) Inventors: Robert I. LEVY, Los Gatos, CA (US); Paul R. PATTERSON, Monte Sereno, CA (US)

(73) Assignee: PRICETECTOR, INC., Los Gatos, CA (US)

(21) Appl. No.: 13/230,615

(22) Filed: Sep. 12, 2011

(51) Int. Cl. G06Q 30/00

(52) U.S. Cl. 705/14.17

(57) ABSTRACT

A system is provided comprising: a mobile device including an application to obtain purchase information from a physical receipt, wherein the purchase information includes a product identification and a purchase price; a monitoring server designed to receive the purchase information from the application on the mobile device, correlate the purchase information with a retailer, retrieve a retailer purchase protection policy associated with the retailer, wherein the retailer purchase protection policy contains limitations under which a credit can be authorized, monitor a current price for a product identified by the product information, and, when the current price for the product drops below the purchase price and the limitations of the retailer purchase protection policy have not been violated, send the purchase information to the retailer with as request for a credit.

### BACKGROUND OF THE INVENTION

1. Field of the Invention

The present invention relates generally to refunds and rebates. More particularly, the present invention relates to a system and method for crediting automatic refunds and rebates back to customers of retailers.

2. Description of the Related Art

In the face of the increase in use of the Internet to shop rather than using traditional brick-and-mortar retailers, and the ensuing ease of comparison shopping based on price that the Internet has made available to consumers, more and more brick-and-mortar retailers have begun offering price protection to consumers who purchase from them. Typically this price protection is made in the form of a guarantee that if the user finds a competitor selling the same item for less money during a specified time window (generally, 30, 60, or 90 days), that the retailer will refund the difference between the actual amount the consumer paid originally and the price he or she could obtain from a competitor. Not only does this give the consumer confidence in making the initial purchase from the brick-and-mortar retailer, but it also helps reduce returns, which can be costly for brick-and-mortar retailers.

In addition to protecting the consumer in cases where a competitor offers a product for less money within the specified time period, the price protection generally also extends to the retailers own prices, in that should the retailer drop the price or offer a sale on the product within the specified time period, the consumer is also able to obtain a refund.

This type of price protection, however, is rarely utilized by the consumer. Most consumers do not have the time to monitor a retailer's price of a product, and even less time to bring the receipt back to the retailer and obtain a refund within the specified time period. As such, a large number of potential refunds go unredeemed.

At the same time, many brick-and-mortar stores are suffering in the face of online competition, and could stand to benefit from more loyalty from repeat customers.

What is needed is a solution that addresses these issues.

### SUMMARY OF THE INVENTION

In a first embodiment of the present invention, a system for enabling price protection from retailer for a customer is provided, the system comprising: a mobile device, wherein the mobile device includes an application operated by the customer to obtain purchase information from a physical receipt, wherein the purchase information includes a product identification and a purchase price; a monitoring server designed to receive the purchase information from the application on the mobile device, correlate the purchase information with a retailer, retrieve a retailer purchase protection policy associated with the retailer, wherein the retailer purchase protection policy contains limitations under which a credit can be authorized, monitor a current price for a product identified by the product information, and, when the current price for the product drops below the purchase price and the limitations of the retailer purchase protection policy have not been violated, send the purchase information to the retailer with a request for a credit; and wherein the monitoring server is further designed to receive an indication from the retailer server that a credit has been issued and to send this decision to the mobile device for display to the customer.

In a second embodiment of the present invention, a method for enabling price protection from retailer for a customer is provided, the method comprising: receiving purchase information regarding a purchase made by a customer at a retailer from a mobile device, wherein purchase information includes at least a product identification and purchase price; determining a retailer associated with the purchase; retrieving a stored price protection policy for the retailer, wherein the stored price protection policy includes limitations as to when a price protection credit can be obtained; monitoring a current price for a product associated with the product identification, within the limitations of the stored price protection policy; when the current price for the product associated with the product identification falls below the purchase price, within the limitations of the stored price protection policy, sending the purchase information to a retailer with a request for a credit for the customer; receiving an indication that a credit has been granted for the customer; and sending the indication to the user.

In a third embodiment of the present invention, a non-transitory program storage device readable by a machine tangibly embodying a program of instructions executable by the machine to perform a method for enabling price protection from retailer for a customer is provided, the method comprising: obtaining purchase information regarding a purchase made by a customer at a retailer, wherein purchase information includes at least a product identification, a purchase price, and a retailer identification; retrieving a stored price protection policy for a retailer associated with the retailer identification, wherein the stored price protection policy includes limitations as to when a price protection credit can be obtained; monitoring a current price for a product associated with the product identification, within the limitations of the stored price protection policy; when the current price for the product associated with the product identification falls below the purchase price, within the limitations of the stored price protection policy, sending the purchase information to a retailer with a request for a credit for the customer; receiving a credit on behalf of the customer from the retailer server; and sending the credit to the customer.

In a fourth embodiment of the present invention, an apparatus for enabling a retail transaction between a brick-and-mortar retailer and a customer is provided, the apparatus comprising: means for receiving purchase information regarding a purchase made by a customer at a retailer from a mobile device, wherein purchase information includes at least a product identification and purchase price; means for determining a retailer associated with the purchase; means for retrieving a stored price protection policy for the retailer, wherein the stored price protection policy includes limitations as to when a price protection credit can be obtained; means for monitoring a current price for a product associated with the product identification, within the limitations of the stored price protection policy; means for, when the current price for the product associated with the product identification falls below the purchase price, within the limitations of the stored price protection policy, sending the purchase information to a retailer with a request for a credit for the customer; means for receiving an indication that a credit has been granted for the customer; and means for sending the indication to the user.

### BRIEF DESCRIPTION OF THE DRAWINGS

FIG. 1 is a diagram illustrating a system for providing price protection in accordance with an embodiment of the present invention.

FIG. 2 is a diagram illustrating a system for providing price protection in accordance with another embodiment of the present invention.

FIG. 3 is a diagram illustrating a system for providing price protection in accordance with another embodiment of the present invention.

FIG. 4 is a diagram illustrating a point-of-sale system that may be utilized with an embodiment of the present invention.

FIG. 5 is a flow diagram illustrating a method for enabling price protection from a retailer for a customer in accordance with an embodiment of the present invention.

FIG. 6 is a flow diagram illustrating a method for enabling price protection from a retailer for a customer in accordance with another embodiment of the present invention.

FIG. 7 is a screen capture depicting a registration screen in accordance with an embodiment of the present invention.

FIG. 8 is a screen capture depicting a main menu screen in accordance with an embodiment of the present invention.

FIG. 9 is a screen capture depicting a protect purchase screen in accordance with an embodiment of the present invention.

FIG. 10 is a screen capture depicting a selection of retailer screen in a pick my price module in accordance with an embodiment of the present invention.

FIG. 11 is a screen capture depicting a screen for scanning a receipt in accordance with an embodiment of the present invention.

FIG. 12 is a screen capture depicting a confirmation screen in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, a system is provided that automatically monitors for price reductions at a retailer, and then automatically provides a rebate to the customer when a price reduction occurs on a purchased product within a specified time period. This allows the customer to enjoy the full protection provided by the price protection policy of a retailer. The retailer also benefits, in that the customer becomes a much more loyal customer when he or she is secure with the knowledge that the price protection policy will be invoked automatically. Additionally, price rebates may be issued in the form of store credit, thus ensuring a repeat visit from the customer who then may purchase additional items costing amounts above-and-beyond the credit amount.

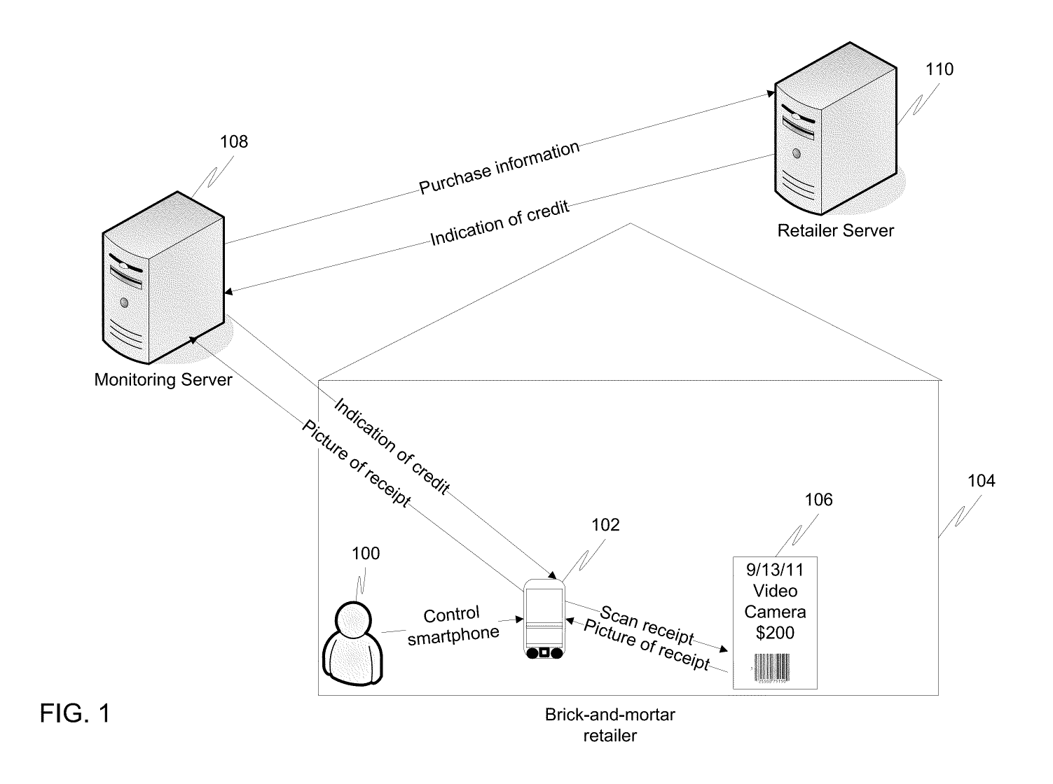

FIG. 1 is a diagram illustrating a system for providing price protection in accordance with an embodiment of the present invention. Here, user 100 operates a smartphone 102. The user 100 uses a camera on the smartphone 102 to capture a picture of a receipt of an item recently purchased at brick and mortar retailer 104. Because the smartphone 102 is mobile and likely to be carried at most times by the user 100, it is easy for the user 100 to capture the receipt 106 either immediately after purchase (i.e., while still in the store, as depicted here), or shortly thereafter. As will be described later, certain incentives may be provided to persuade the user 100 to capture the receipt quickly.

The smartphone 102 then sends the scanned receipt to a monitoring server 108. The monitoring server 108 extracts data from the receipt, including information identifying the retailer, product, and price. Then the monitoring server 108 checks for a stored price drop policy for the identified retailer. The policy will likely contain terms and conditions of the stores price drop program, including a number of days that the price drop policy is in effect following purchase. The monitoring server 108 then can obtain updated price information, either provided from the retailer or the server may actively go out and attempt to retrieve price information from, for example, retailer web sites. If a price drop for the identified product is detected within a time period specified by the retailer's price drop policy, the server identifies the user as being eligible for a rebate. The monitoring server 108 can then contact the retailer (through retailer server 110) on the user's behalf to request a rebate. The rebate may be provided in the form of a store credit, which is indicated to the monitoring server 106, and which can then be communicated to the user 100. The store credit may simply be made available to the user the next time a purchase is made, or a special card may be sent out physically to the user from the retailers. In some circumstances, the middleman controlling monitoring server 108 can act to send out the card. Nevertheless, this card is merely store credit, not cash. As such, the monitoring server 108 acts only as a facilitator between the user and the retailer, and does not act as a financial institution providing cash to users.

While in the above-described embodiment, the purchase information is obtained by taking a photograph of a physical receipt by a mobile device for uploading to a server, the purchase information can actually be obtained in a number of different ways. First of all, the physical receipt itself can be used to obtain the purchase information in different ways than merely taking a digital photograph of it. For example, some receipts contain barcode information on them to enable retailers to easily scan them when customers want to return a product. This barcode could be scanned using a barcode scanner, or a digital photograph of just the barcode could be taken to essentially scan the barcode using a mobile device. Alternatively, the purchase information can be obtained solely by using backend means. For example, the server may have a connection to a retailer database that keeps records of all transactions. The server may simply go directly to the retailer database for the record. Alternatively, the server may be able to connect to a credit card server where purchase information is kept on the credit card side, although in such instances usually just the retailer name, date, and purchase amount is kept. However, this information could theoretically be combined with information from the retailer server to obtain purchase information. In another embodiment, the user can manually enter purchase information using an application on his or her mobile device. In another embodiment, various combinations of the above-described means are used. For example, information from the receipt may be used as an index to retrieve purchase information from a backend database.

While FIG. 1 depicts a receipt being scanned and the entire scanned receipt being sent to the server for analysis, some or all of the analysis of the receipt to extract the purchase information may be conducted on the mobile device. For example, optical character recognition (OCR) software can be utilized to convert the picture of the receipt into usable and identifiable data involving the transaction. The OCR process can be performed entirely on the server, entirely on the mobile device, or using a combination of the mobile device and the server.

In another embodiment of the present invention, a distinction may be made between a preferred retailer and a non-preferred retailer. A preferred retailer is one that partners with the system to permit automatic execution of the purchase protection program as described above. A non-preferred retailer is one that has not so partnered. In such instances, rather than causing an automatic execution of the purchase protection program, the system can advocate to the non-preferred retailer on behalf of the customer. For example, when the system, though monitoring of product prices on a retailer web page, learns that a product which was purchased by a registered customer has fallen in price, an email can be sent to the retailer including the customer information and proof of the purchase in order to attempt to receive a credit. Alternatively, the system may provide a form email or letter with certain fields automatically filled out and present it to the customer so that they can request a credit directly.

In another embodiment of the present invention, the credit issued to the customer can contain certain restrictions. For example, the credit may expire after a certain number of days, or may be valid only on certain items, in certain locations, etc. In one embodiment of the present invention, the restrictions placed on the credit may vary based on the customer. For example, more frequent or valued customers may have fewer restrictions than less frequent or less valued customers.

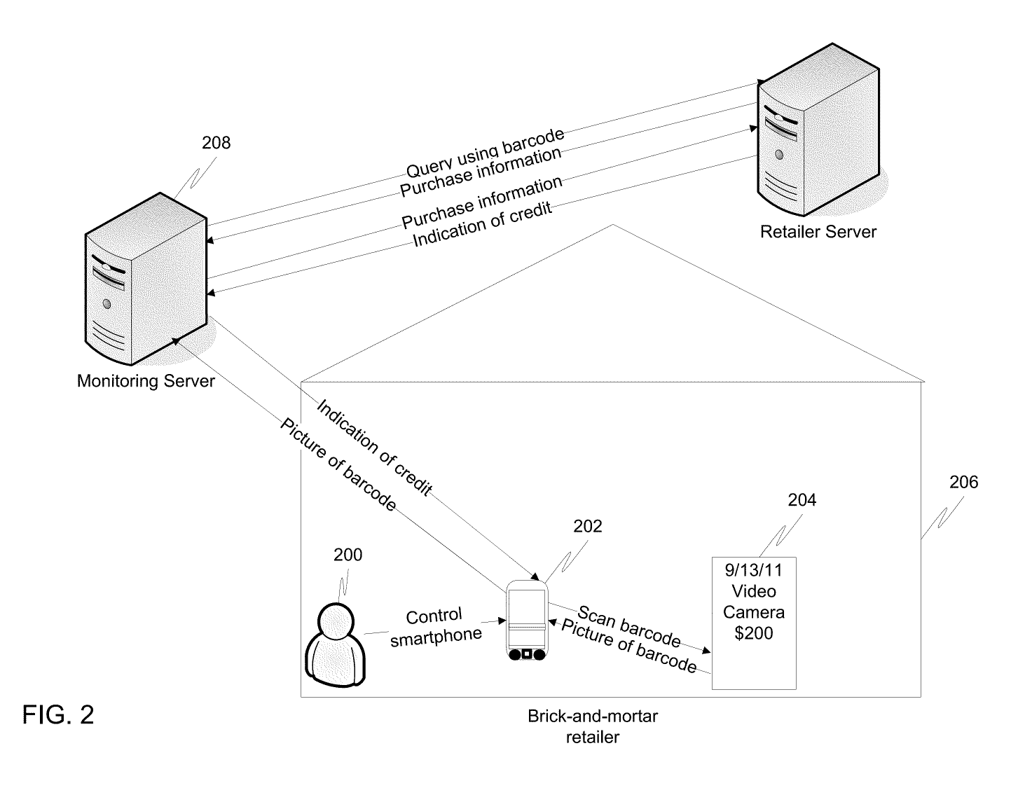

FIG. 2 is a diagram illustrating a system for providing price protection in accordance with another embodiment of the present invention. As with FIG. 1, here user 200 operates a smartphone 202. The user then uses a camera on the smartphone 202 to capture just the barcode from the receipt 204 while at brick and mortar retailer 206.

The smartphone 202 then sends the barcode information to a monitoring server 208. The monitoring server 208 extracts data from the barcode and uses this information either directly (in the case where all the purchase information is encoded in the barcode), or indirectly (in the case where the barcode is simply an index to a backend database where purchase information is stored) to obtain purchase information, including information identifying the retailer, product, and price. Then the monitoring server 208 checks for a stored price drop policy for the identified retailer. The monitoring server 208 then can obtain updated price information, either provided from the retailer or the server may actively go out and attempt to retrieve price information from, for example, retailer web sites. If a price drop for the identified product is detected within a time period specified by the retailer's price drop policy, the server identifies the user as being eligible for a rebate. The server can then contact the retailer on the user's behalf to request a rebate. The automatic monitoring of prices from retailer web sites may be performed on a periodic basis using a bot designed to scrub prices from retailer web sites.

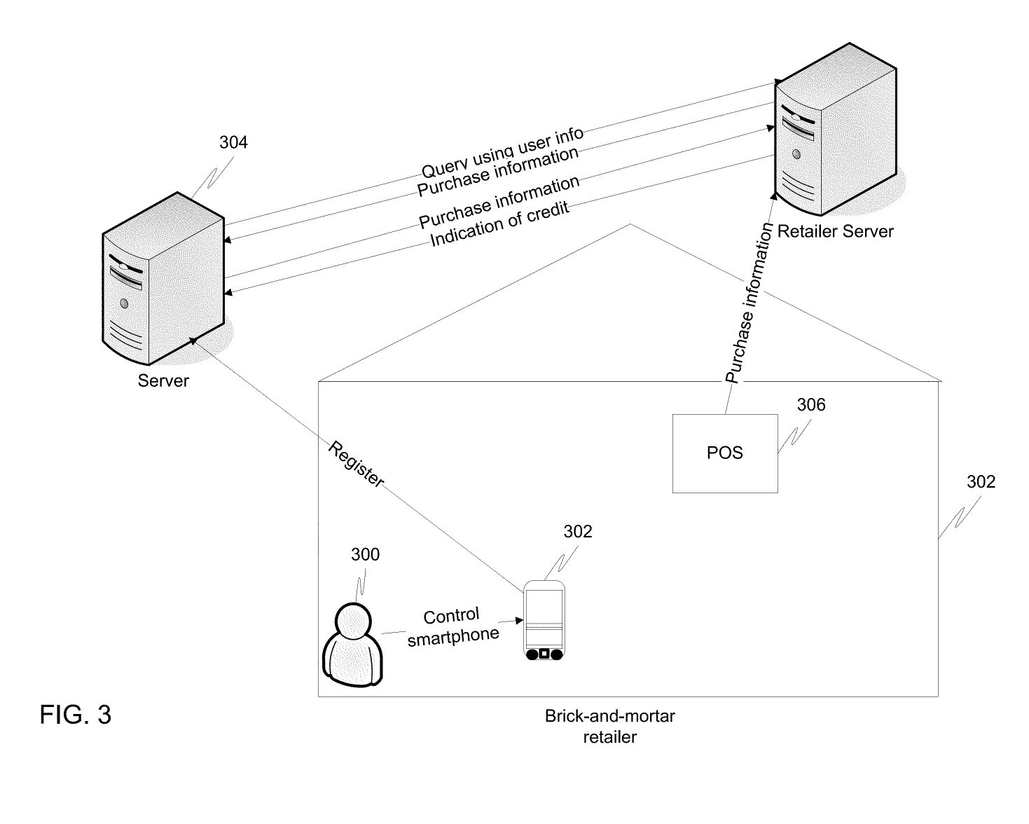

FIG. 3 is a diagram illustrating a system for providing price protection in accordance with another embodiment of the present invention. Here the user 300 makes a purchase at retailer 302, but does not directly notify the monitoring server 304 of this purchase. Rather, the monitoring server 304 interfaces with a POS/transaction database system 306 operated by the retailer 302 to obtain purchase information. In this case, the user 300 has previously registered with the monitoring server 304, perhaps using mobile device 302, and thus any purchase information retrieved from the POS/transaction database system 306 for the identified user 300 can be correlated with a user's account with the monitoring server 304. The monitoring server 304 can then check for a stored price drop policy for the identified retailer. The monitoring server 304 then can obtain updated price information, either provided from the retailer or the server may actively go out and attempt to retrieve price information from, for example, retailer web sites. If a price drop for the identified product is detected within a time period specified by the retailer's price drop policy, the server identifies the user as being eligible for a rebate. The server can then contact the retailer on the user's behalf to request a rebate.

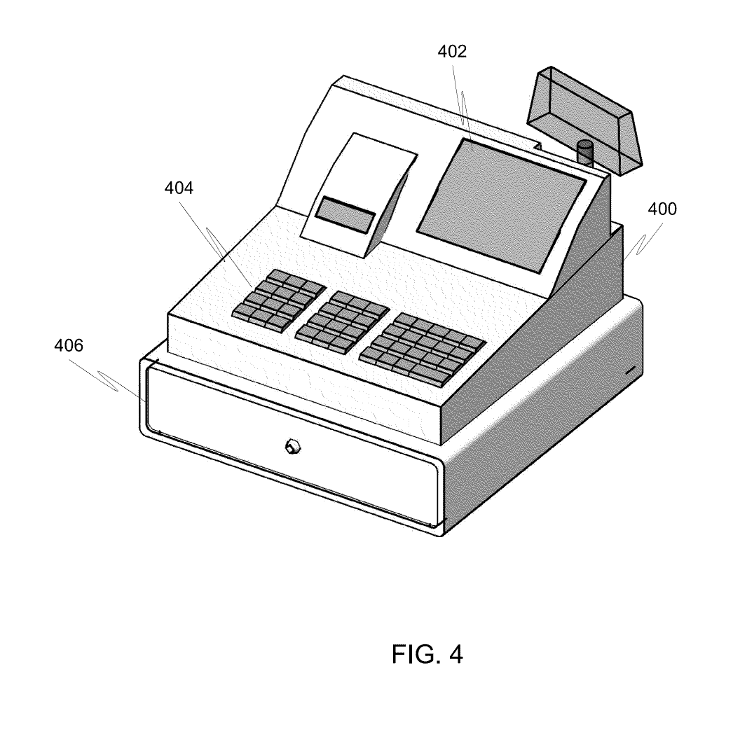

FIG. 4 is a diagram illustrating a point-of-sale system that may be utilized with an embodiment of the present invention. The front-end portion of the POS system comprises a personal computer 400 or similar computer system, including a display 402, and one or more input devices such as a keyboard 404 and barcode scanner (not pictured). The front-end POS system also includes a cash drawer component 406, much like a traditional cash register. The cash drawer component can be opened by the front-end POS application program running on the computer. The front-end POS system can further include a receipt printing device that can print out a sale receipt at the end of the transaction. The front-end POS system can be used at each check-out line in at the brick-and-mortar retailer.

The front-end POS system essentially performs the same tasks as a traditional cash register machine, except it is electronic and may be networked to a centralized inventory/product database. A sales clerk can scan items to be purchased using the barcode scanner, or input product information via an input device such as keyboard 404. The front-end application program running on the computer then can correlate scanned product identifiers, such as barcodes or QR codes, with entries within the inventory/product database. Such entries may include a text description of the product, the price of the product, information as to whether the product is taxable, etc.

The front-end POS system may be electronically linked to a backroom server at the brick-and-mortar retailer. The backroom server contains the management and control software that collects transaction information from the networked POS systems, processes the collected information, and carries out management and maintenance tasks for the brick-and-mortar retailer. This may include, for example, inventory control, and accounting.

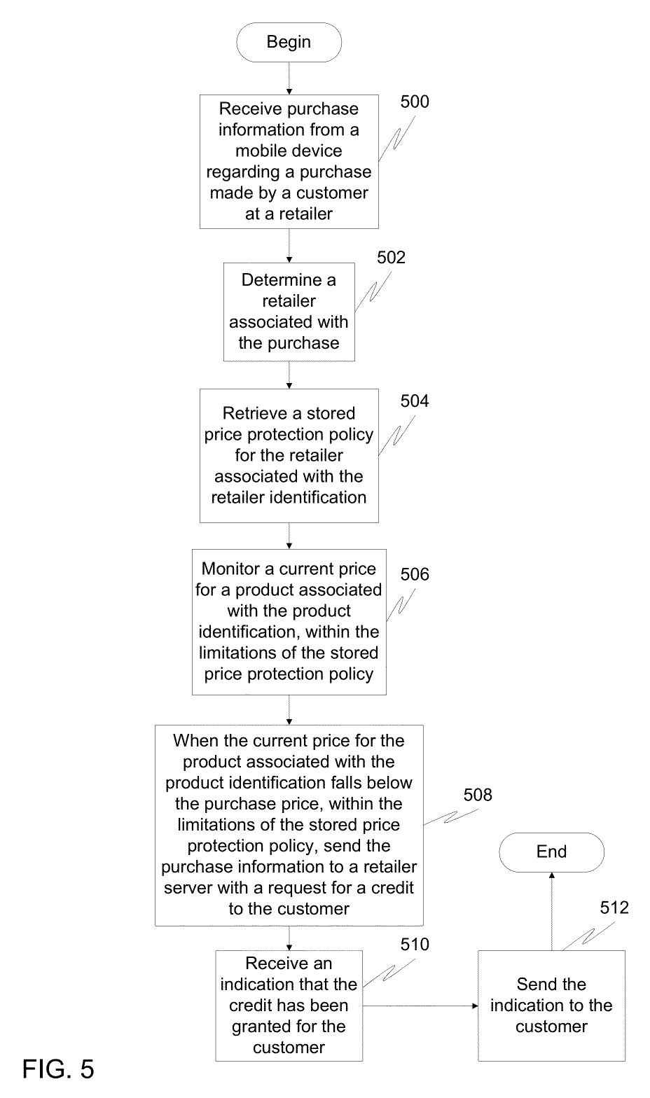

FIG. 5 is a flow diagram illustrating a method for enabling price protection from a retailer for a customer in accordance with an embodiment of the present invention. At 500, purchase information regarding a purchase made by a customer at a retailer is received from a mobile device. At 502, a retailer associated with the purchase may be determined. This may either be done implicitly or explicitly. For example, a retailer identification may be included on the receipt. Alternatively, the user can specify the name of the retailer in an application on the mobile device, and this information can be transmitted to the monitoring server. In another alternative, the retailer can be deduced based on past purchase information. At 504, a stored price protection policy is retrieved for the retailer. The stored price protection policy includes limitations (e.g., time limit, location limits, product limitations, customer limitations) as to when a price protection credit can be obtained.

At 506, a current price for a product associated with the product identification is monitored, within the limitations of the stored price protection policy. Within the limitations of the stored price protection policy reflects the fact that it is not necessary to continue to monitor price fluctuations of a product if the price protection policy would no longer offer a credit, such as if the time limit for the price protection policy has expired. At 508, when the current price for the product associated with the product identification falls below the purchase price, within the limitations of the stored price protection policy, the purchase information is sent to a retailer server with a request for a credit to the customer.

At 510, an indication that the credit has been granted for the customer is received. At 512, the indication is sent to the customer.

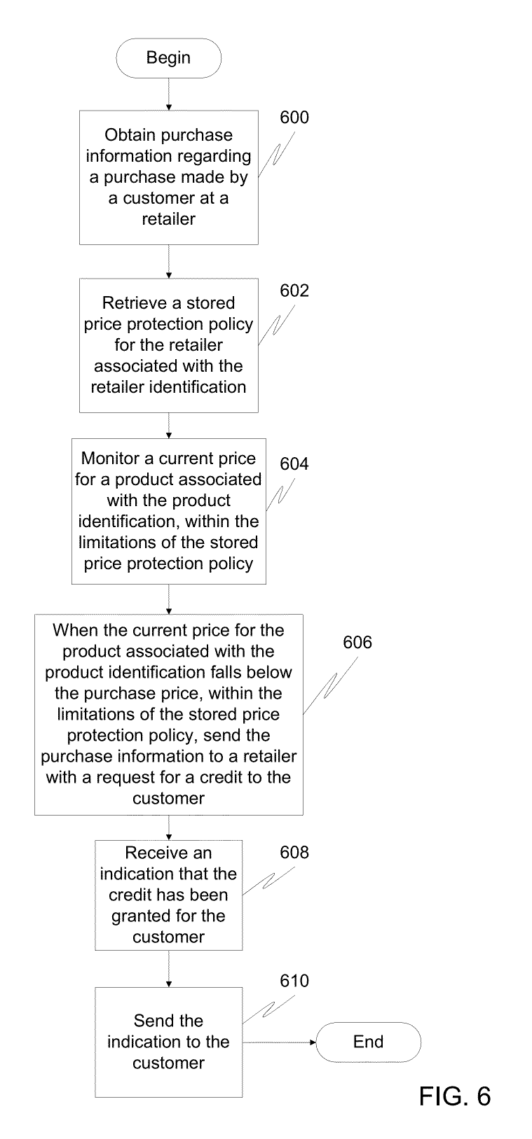

FIG. 6 is a flow diagram illustrating a method for enabling price protection from a retailer for a customer in accordance with another embodiment of the present invention. At 600, purchase information regarding a purchase made by a customer at a retailer is obtained. The purchase information includes at least a product identification, a purchase price, and a retailer identification. At 602, a stored price protection policy is retrieved for the retailer associated with the retailer identification. The stored price protection policy includes limitations (e.g., time limit, location limits, product limitations, customer limitations) as to when a price protection credit can be obtained.

At 604, a current price for a product associated with the product identification is monitored, within the limitations of the stored price protection policy. At 606, when the current price for the product associated with the product identification falls below the purchase price, within the limitations of the stored price protection policy, the purchase information is sent to a retailer with a request for a credit to the customer.

At 608, an indication that the credit has been granted for the customer is received. At 610, the indication is sent to the customer.

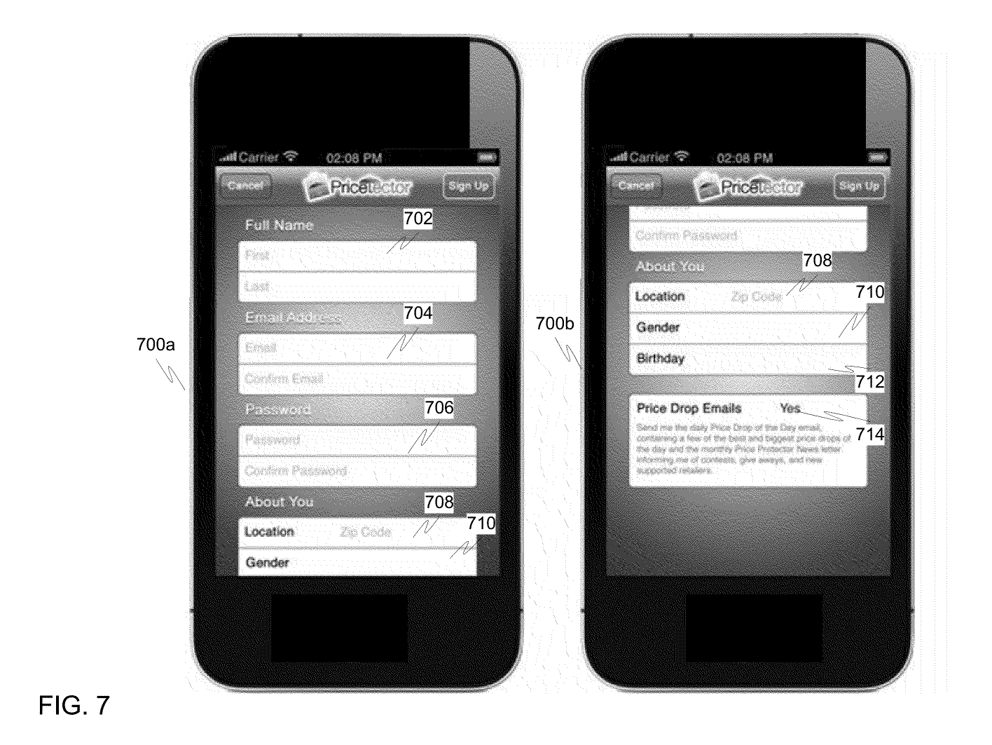

FIG. 7 is a screen capture depicting a registration screen in accordance with an embodiment of the present invention. The screen is depicted in two parts 700a, 700b, due to the length of the information presented. The user may scroll up or down to see the information in 700a and 700b, respectively. As can be seen, there are fields presented for the user to enter his or her name 702, email address 704, and a password 706. There are also fields where the user can enter more detailed personal information, such as location 708, gender 710, and birthday 712. This is, of course, merely an example of the types of information that can be provided during registration. There is also a field 714 where the user may select to receive price drop emails. A price drop email is a daily email indicating the largest price drops available from partner retailers. This email could also be used to communicate deals that are offered based on other customers offers for product. For example, if enough people bid for a $10 discount on a particular product, the retailer may elect to send out the same deal to select other (valued) customers that weren't even bidding on the product. The price drop email may be utilized to convey this information.

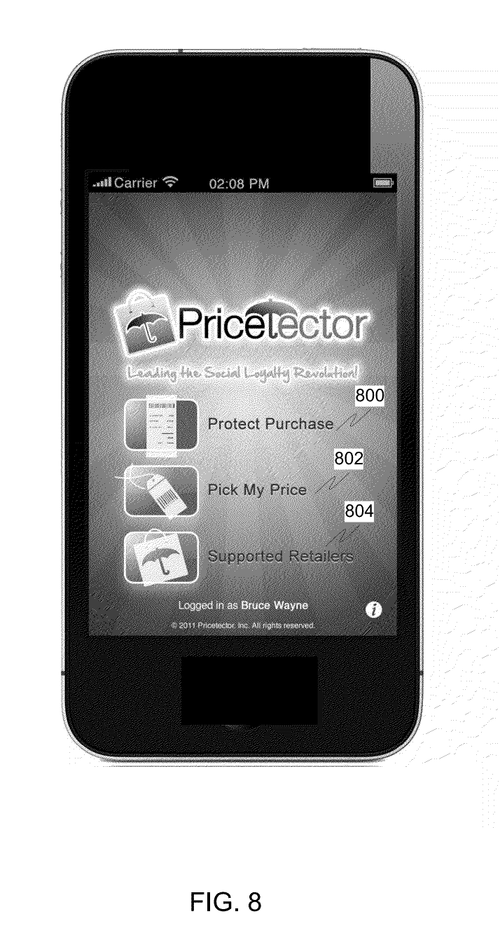

FIG. 8 is a screen capture depicting a main menu screen in accordance with an embodiment of the present invention. Here, the user is able to select from various modules, including a protect purchase module 800, a pick my price module 802, and a supported retailers module 804. The supported retailers module 804 allows the user to view a list of retailers supported by the system. Most relevant for the present invention is the protect purchase module 800.

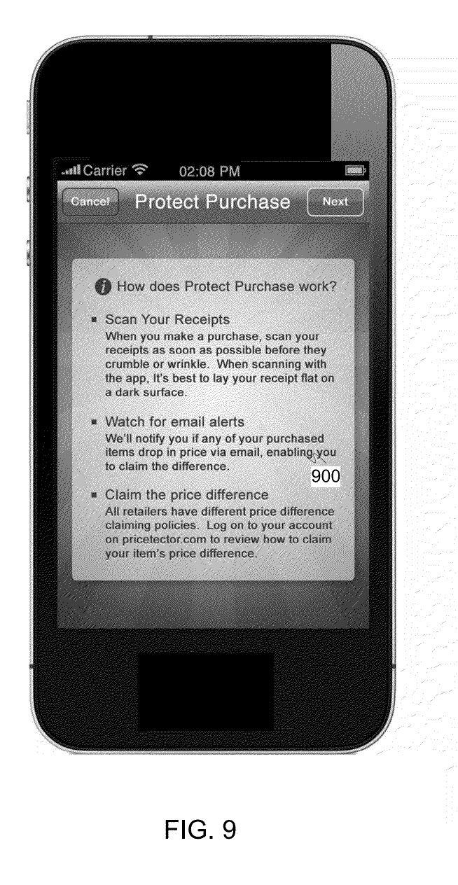

FIG. 9 is a screen capture depicting a protect purchase screen in accordance with an embodiment of the present invention. Here, the user has selected the protect purchase module, and is first presented with a brief description 900 of how the module works. As is described on the screen, the user scans the receipts for purchase, and the application automatically uploads the purchase information to a server that monitors for price drops. The user then watches for alerts (here, email alerts) for indications on when credits are granted.

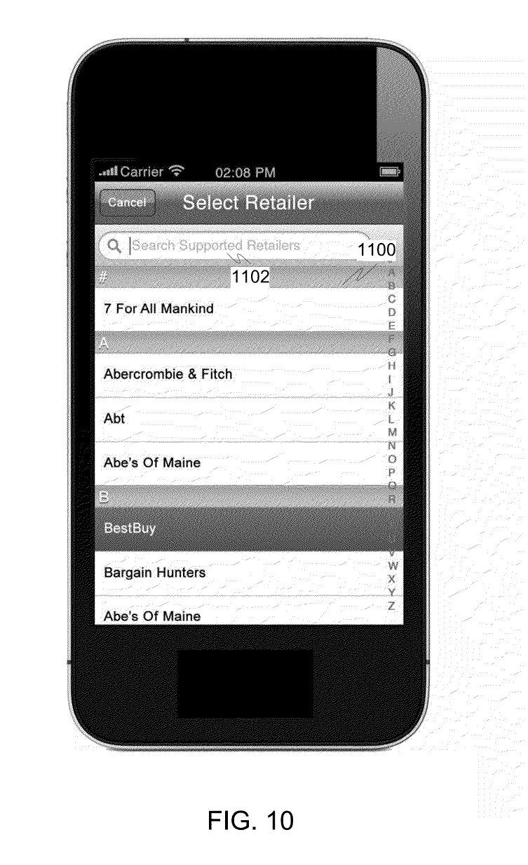

FIG. 10 is a screen capture depicting a selection of retailer screen in a pick my price module in accordance with an embodiment of the present invention. A list of retailers participating in the program is provided at 1000, and the user may either scroll through the list or utilize a search field 1002. The user may then select at which the purchase was made. It should be noted that while in this embodiment the user manually enters the retailer information, other embodiments are possible where this information is gathered automatically. For example, the mobile device may be able to detect which store it is currently located in using GPS or other location-tracking elements. Alternatively, the next step, where a barcode or other product identification is obtained, may also inform the system as to the location of the user (e.g., if the barcode contains a unique identifier for the retailer as well as identifying the product).

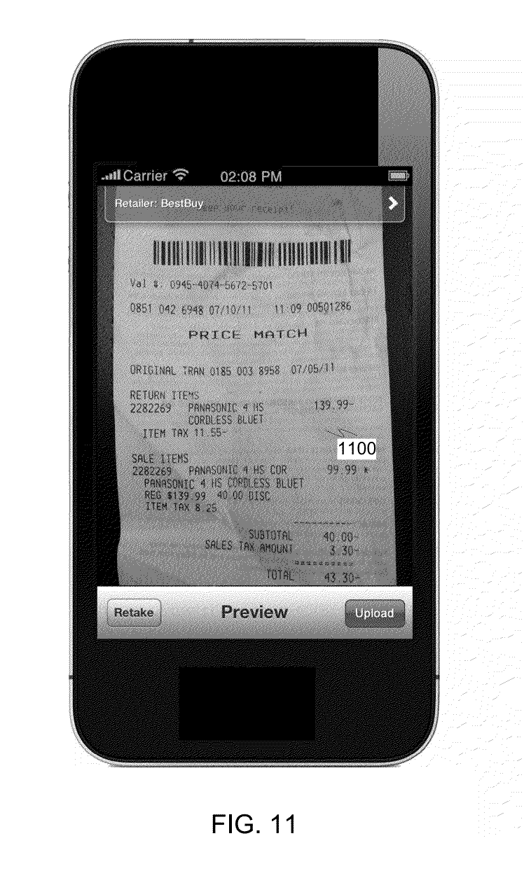

FIG. 11 is a screen capture depicting a screen for scanning a receipt in accordance with an embodiment of the present invention. The user may orient the receipt 1100 to correlate with the orientation of the device and then snap a picture.

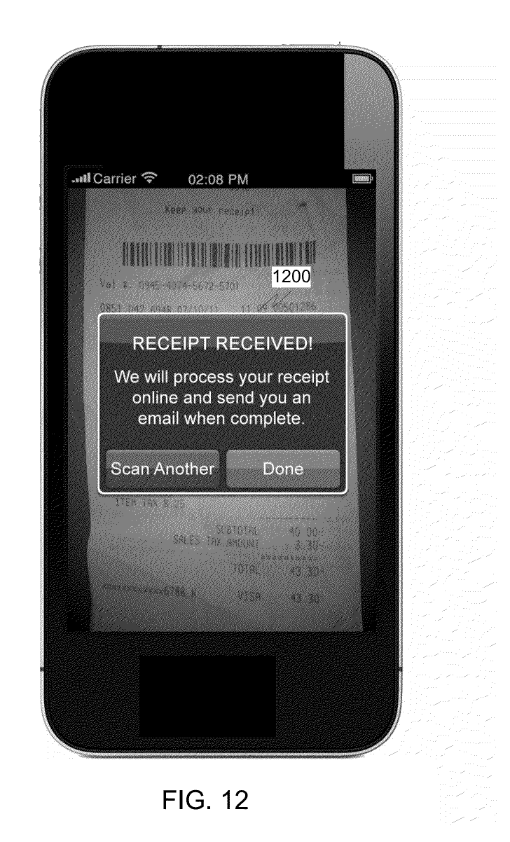

FIG. 12 is a screen capture depicting a confirmation screen in accordance with an embodiment of the present invention. Here, the user receives confirmation 1200 that the receipt was received. If the receipt cannot be deciphered, this is the point at which the user may be alerted to rescan the receipt.

It should be noted that the term “brick-and-mortar retailer” shall be construed to mean any business having a physical presence at which a customer may visit in order to purchase an item. In that respect, a “brick-and-mortar retailer” can be differentiated from an “online retailer” where the customer visits only a virtual store via the Internet or other data network. However, one of ordinary skill in the art recognizes that many “brick-and-mortar” retailers also operate as “online retailers” and vice-versa. As such, for purposes of this document, in cases wherein a retailer has both a brick-and-mortar physical presence and an online presence, the “brick-and-mortar retailer” shall be construed to mean the brick-and-mortar presence of the retailer.

In an embodiment of the present invention, a specialized application, or “app” may be installed on the user's smartphone or other mobile device that acts as the user agent to gather purchase information from a receipt, transmit the purchase information to a server, and ultimately receive and display an indication of a credit. In some embodiments, the app may also include a mechanism that can be used to redeem the credit. For example, the server may provide a special code which the user can present to the retailer by launching the app and displaying the code, which the retailer can then use to correlate with a credit in their system. This app may be available through an “app store”, via which the user may download the app and install it on his or her mobile device. The app may provide a user interface for the user to select various tasks. The app may also interface with one or more hardware components of the smartphone or other mobile device to obtain the purchase information As described above, this might involve using a camera embedded in the mobile device to scan a receipt, or a barcode or QR code. The obtained information may then be communicated to the server via a wireless networking protocol. This may include cellular phone data networks such as EDGE, 3G, 4G, LTE, and others, as well as other data networks such as WiFi, and WiMax. In one embodiment of the present invention, the app may be integrated directly into the wireless carrier's system, enabling communication between the app and the user information aggregation server via ordinary cellular communications (GSM, CDMA, AMPS, or via SMS text messages).

As described briefly earlier in this document, the customer may be incentivized to scan the receipt quickly. This helps ensure that the purchase information is captured in a timely manner. Statistics show that users are much less likely to scan in the receipt as more and more time elapses from the time of the purchase. As such, it is greatly beneficial to scan the receipt as soon as possible after the purchase is made. The app running on the mobile device aids greatly in the ability of the user to scan the receipt quickly, even allowing the user to do so immediately after the receipt is given to him or her by the cashier. While it is also possible for the receipt to be captured later, either by the mobile device or through another mechanism (such as a scanner attached to a home computer), the incentives act to encourage the customer to do so using the mobile device shortly after purchase. One example incentive is to provide better rewards to the customer, either in the form of the credit or in additional rewards, based on how quickly the receipt is scanned. For example, the user's credit may have a 90 day limit if the user scanned the receipt within an hour of purchase, and a 30 day limit if the user scanned the receipt later. Another example incentive is to make a game out of it. Users may be assigned points based on how quickly receipts are scanned. They may then be provided with an overall score that they can compare with their friends, causing competition to encourage quick scanning. Another example would be to provide a better “deal” on a future purchase for a customer who scans his or her receipts quickly than for one who does not.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A system for enabling price protection from retailer for a customer, the system comprising:
a mobile device, wherein the mobile device includes an application operated by the customer to obtain purchase information from a physical receipt, wherein the purchase information includes a product identification and a purchase price;
a monitoring server designed to receive the purchase information from the application on the mobile device, correlate the purchase information with a retailer, retrieve a retailer purchase protection policy associated with the retailer, wherein the retailer purchase protection policy contains limitations under which a credit can be authorized, monitor a current price for a product identified by the product information, and, when the current price for the product drops below the purchase price and the limitations of the retailer purchase protection policy have not been violated, send the purchase information to the retailer with a request for a credit; and
wherein the monitoring server is further designed to receive an indication from the retailer server that a credit has been issued and to send this decision to the mobile device for display to the customer.

2. The system of claim 1, wherein the monitoring server is designed to receive information about the current price from the retailer server.

3. The system of claim 1, wherein the monitoring server is designed to automatically retrieve the current price from a web site associated with the retailer.

4. The system of claim 1, wherein the mobile device contains a camera and wherein the obtaining of purchase information from the physical receipt includes taking a picture of the physical receipt using the camera.

5. The system of claim 1, wherein the mobile device contains a camera and wherein the obtaining of purchase information from the physical receipt includes taking a picture of a barcode located on the physical receipt using the camera.

6. A method for enabling price protection from retailer for a customer, the method comprising:
receiving purchase information regarding a purchase made by a customer at a retailer from a mobile device, wherein purchase information includes at least a product identification and purchase price;
determining a retailer associated with the purchase;
retrieving a stored price protection policy for the retailer, wherein the stored price protection policy includes limitations as to when a price protection credit can be obtained;
monitoring a current price for a product associated with the product identification, within the limitations of the stored price protection policy;
when the current price for the product associated with the product identification falls below the purchase price, within the limitations of the stored price protection policy, sending the purchase information to a retailer with a request for a credit for the customer;
receiving an indication that a credit has been granted for the customer; and
sending the indication to the user.

7. The method of claim 6, wherein the monitoring includes use of an automated bot to search retailer websites and gather current pricing information.

8. The method of claim 7, wherein the bot retrieves price information from retailers on a periodic basis.

9. A non-transitory program storage device readable by a machine tangibly embodying a program of instructions executable by the machine to perform a method for enabling price protection from retailer for a customer, the method comprising:
obtaining purchase information regarding a purchase made by a customer at a retailer, wherein purchase information includes at least a product identification, a purchase price, and a retailer identification;
retrieving a stored price protection policy for a retailer associated with the retailer identification, wherein the stored price protection policy includes limitations as to when a price protection credit can be obtained;
monitoring a current price for a product associated with the product identification, within the limitations of the stored price protection policy;
when the current price for the product associated with the product identification falls below the purchase price, within the limitations of the stored price protection policy, sending the purchase information to a retailer with a request for a credit for the customer;
receiving a credit on behalf of the customer from the retailer; and
sending the credit to the customer.

10. The non-transitory program storage device of claim 9, wherein the purchase information is obtained from a point-of-sale database system controlled by the retailer.

11. The non-transitory program storage device of claim 9, wherein the purchase information is obtained from a transaction system maintained by a credit card company.

12. An apparatus for enabling a retail transaction between a brick-and-mortar retailer and a customer, the apparatus comprising:
means for receiving purchase information regarding a purchase made by a customer at a retailer from a mobile device, wherein purchase information includes at least a product identification and purchase price;
means for determining a retailer associated with the purchase;
means for retrieving a stored price protection policy for the retailer, wherein the stored price protection policy includes limitations as to when a price protection credit can be obtained;
means for monitoring a current price for a product associated with the product identification, within the limitations of the stored price protection policy;
means for, when the current price for the product associated with the product identification falls below the purchase price, within the limitations of the stored price protection policy, sending the purchase information to a retailer with a request for a credit for the customer;
means for receiving an indication that a credit has been granted for the customer; and
means for sending the indication to the user.
